(19) United States
(12) Patent Application Publication
(10) Pub. No.: US 2015/0134192 A1
(43) Pub. Date: May 14, 2015

(54) EXTERNAL DIAGNOSIS DEVICE, VEHICLE DIAGNOSIS SYSTEM AND VEHICLE DIAGNOSIS METHOD

(71) Applicant: HONDA MOTOR CO., LTD., Tokyo (JP)

(72) Inventor: Hiroyuki Kakinuma, Saitama-shi (JP)

(21) Appl. No.: 14/400,838

(22) PCT Filed: Apr. 9, 2013
(86) PCT No.: PCT/JP2013/060677

§ 371 Date: Nov. 13, 2014

(30) Foreign Application Priority Data
May 25, 2012 (JP) 2012-119128

(51) Int. Cl. G07C 5/00

(52) U.S. Cl. CPC G07C 5/008
USPC 701/31.4

(57) ABSTRACT

An external diagnosis device, vehicle diagnosis system and vehicle diagnosis method assess the degree of degradation of a vehicle for diagnosis in relation to items for diagnosis, by comparing: multiple threshold values that, for items for diagnosis that are mutually identical, have been set in accordance with the degree of aging of the vehicle for diagnosis, and have been set in relation to the degree of degradation of said vehicle for diagnosis; and a sensor detection value acquired from the vehicle for diagnosis.

### TECHNICAL FIELD

The present invention relates to an external diagnosing apparatus, a vehicle diagnosing system, and a vehicle diagnosing method for diagnosing a vehicle.

### BACKGROUND ART

If a vehicle suffers from a fault, the vehicle is taken to the repair shop of the dealer or the like. The operator (technician) who is responsible for repairing the vehicle connects an electronic control unit (hereinafter referred to as an “ECU”) on the vehicle to an external diagnosing apparatus, reads fault data (diagnostic trouble codes) from the ECU, analyzes a defective component or a fault source, and measures operating parameters of the vehicle to perform an analysis and compares the operating parameters with reference values for carrying out necessary repairs or adjustments.

External diagnosing apparatus of the above type are arranged to deal with a situation in which a diagnostic reference value, which was set at the time of shipment of the vehicle, needs to be corrected after the vehicle has been shipped. See, Japanese Laid-Open Patent Publication No. 2003-120355 (hereinafter referred to as “JP 2003-120355 A”) and Japanese Patent Publication No. 04-070573 (hereinafter referred to as “JP 04-070573 B”).

According to JP 2003-120355 A, both electronic control units 3 through 6 (vehicle-mounted ECUs) in a vehicle 2 and a vehicle fault diagnosing apparatus 1 (external diagnosing apparatus) have reference value data (paragraphs [0006], [0039]). When the electronic control units 3 through 6 receive a diagnostic data request from the vehicle fault diagnosing apparatus 1, the electronic control units 3 through 6 send control data of the vehicle together with reference value identification data representing a reference value generation date (step S62 of FIG. 2, [0043]). The vehicle fault diagnosing apparatus 1 receives the reference value identification data and confirms whether or not an acquired vehicle specification reference value is already in a vehicle data memory 43 (step S64, paragraph [0044]). If the acquired vehicular reference value is already in the vehicle data memory 43, then the vehicle fault diagnosing apparatus 1 compares the received reference value generation date with a reference value generation date stored in the vehicle data memory 43 (step S65, paragraph [0045]). The vehicle fault diagnosing apparatus 1 diagnoses the vehicle 2 using a reference value that has a newer reference value generation date (steps S66-S71, paragraphs [0046]-[0050]).

According to JP 04-070573 B, a reference value inherent in a diagnosed vehicle concerning the vehicle operating state is stored in the diagnosed vehicle, and aging or deterioration of the diagnosed vehicle is detected based on a detected result from a used-state detecting means, which detects a used state of the diagnosed vehicle. The reference value, which is stored in a reference value storing means in the diagnosed vehicle, is changed based on the detected aging or deterioration (claim 1). The stored reference value is an inherent value determined by the model of the diagnosed vehicle, the engine type, the manner in which the diagnosed vehicle has been used, etc. For example, the reference value represents a control parameter or the like, which is changed depending on aging or deterioration of engine parts and actuators (column 6, lines 6 through 15).

### SUMMARY OF INVENTION

The reference value used in JP 2003-120355 A is construed merely as one value or one type concerning each item of data. For dealing with a situation in which a reference value needs to be corrected after the vehicle has been shipped, a selection is simply performed of either one of a reference value, which was determined at the time of shipment, or a reference value that is set uniformly after shipment at the time a correction is required. With the uniformly set reference value, however, a brand-new vehicle, a second-hand vehicle for which a significant time has not elapsed after the vehicle has started to be used, and a second-hand vehicle for which a considerable amount of time has elapsed after the vehicle has started to be used must have similar diagnostic results, assuming that the detected values from the sensors are similar. Actually, however, similar detected values may represent different meanings depending on the degree of aging of the vehicles. For example, when the rotational speed of the engine on a vehicle is detected as fluctuating within a range of 1200 rpm±200 rpm, the fluctuation may be judged as too large, and the vehicle may need to be serviced just in case, if the vehicle is a brand-new vehicle. On the other hand, the same fluctuation may be judged as ordinary if the vehicle is a second-hand vehicle of five years or older.

Further, the reference value used in JP 04-070573 B reflects a history of measurements and a history of changed operating parameters of an individual vehicle. Although the reference value makes it possible to diagnose an individual vehicle in a manner to reflect aging or deterioration of the vehicle, the reference value merely represents an accumulation of vehicular data for each vehicle. Therefore, it is difficult for the external diagnosing apparatus disclosed in JP 04-070573 B to be used as a highly versatile external diagnosing apparatus for diagnosing an unspecified number of vehicles.

The present invention has been made in view of the above problems. It is an object of the present invention to provide an external diagnosing apparatus, a vehicle diagnosing system, and a vehicle diagnosing method for performing a balanced diagnosis on a vehicle, in order to prevent the vehicle from suffering from faults, and to diagnose the vehicle depending on the degree of aging of the vehicle.

According to the present invention, there is provided an external diagnosing apparatus installed on a diagnostic target vehicle for performing data communications with an electronic control unit from outside of the diagnostic target vehicle, to thereby acquire detected values from sensors on the diagnostic target vehicle through the electronic control unit, and for diagnosing the diagnostic target vehicle, wherein the external diagnosing apparatus compares a plurality of threshold values, which are set with respect to a degree of deterioration of the diagnostic target vehicle and set also depending on a degree of aging of the diagnostic target vehicle with respect to a diagnostic target item, with the detected values acquired from the diagnostic target vehicle, for thereby judging the degree of deterioration of the diagnostic target vehicle with respect to the diagnostic target item.

According to the present invention, a plurality of threshold values for judging a degree of deterioration of the diagnostic target vehicle with respect to a diagnostic target item are set with respect to the degree of deterioration of the diagnostic target vehicle and set also depending on a degree of aging thereof with respect to the diagnostic target item. Consequently, it is possible to diagnose a plurality of degrees of deterioration (e.g., a degree that requires the diagnostic target item to be immediately replaced or repaired, or a degree that requires the diagnostic target item to be replaced or repaired within a predetermined period of time or within a predetermined traveled distance). It is thus possible to perform a balanced diagnosis on the vehicle, in order to prevent the vehicle from suffering from faults in advance, and to diagnose the vehicle depending on the degree of aging of the vehicle.

The plurality of threshold values may include threshold values based on measured values or actual values at a time of inspection upon shipment from the factory with respect to a plurality of vehicles included in the same classification as the diagnostic target vehicle or having an equivalent performance to the diagnostic target vehicle, and threshold values based on measured values or actual values depending on numbers of years that the vehicles have been in use, or traveled distances of the vehicles after the vehicles are sold, and wherein the plurality of threshold values may be set within a range so as not to exceed designed maximum tolerances related to the vehicles.

Generally, as the number of years that a vehicle has been in use or the traveled distance of the vehicle becomes greater, components of the vehicle tend to have greater specification variations. When the vehicle is shipped from the factory, therefore, specification variations may be smaller than the designed maximum tolerances. With the above arrangement, the plural threshold values are set depending on the degree of aging, within a range so as not to exceed the designed maximum tolerances. Accordingly, the degree of deterioration of a diagnostic target item can be judged depending on the degree of aging. Therefore, even if the detected values fall within the designed maximum tolerances, the progress of deterioration can be judged as being relatively fast, etc., thereby leading to a more appropriate diagnosis.

If threshold values that coincide with the degree of aging of the diagnostic target vehicle do not exist among the plurality of threshold values or cannot be used, threshold values set for vehicles whose degree of aging is smaller than the diagnostic target vehicle may be selected, and the detected values may be saved as threshold value data for setting threshold values corresponding to the degree of aging of the diagnostic target vehicle. If deterioration judgment threshold values that coincide with the degree of aging of the diagnostic target vehicle do not exist or cannot be used (due to a shortage of samples or a reduction in the reliability of the threshold values for some reason), then a diagnosis is performed using stricter deterioration judgment threshold values. Consequently, it is possible to avoid overlooking an excessive increase in the degree of deterioration. Further, if measured data that are saved in this case are collected and accumulated, then such measured data can be used as threshold value data for setting threshold values corresponding to degrees of aging that do not exist.

The external diagnosing apparatus may acquire the detected values with respect to the diagnostic target item a plurality of times, calculate an average value, a maximum value, and a minimum value of the acquired detected values, and may compare each of the average value, the maximum value, and the minimum value with the plurality of threshold values. Consequently, the degree of deterioration of the diagnostic target vehicle can be diagnosed in detail.

A vehicle diagnosing system according to the present invention includes a plurality of the above-described external diagnosing apparatus. The vehicle diagnosing system further comprises a server for setting the plurality of threshold values and sending the plurality of threshold values to the plurality of external diagnosing apparatus, wherein the plurality of external diagnosing apparatus send data that represent pairs of the detected values acquired from the diagnostic target vehicle and the degree of aging of the diagnostic target vehicle to the server, and wherein the server corrects the plurality of threshold values using the data that represent pairs of the detected values and the degree of aging, which are received from the plurality of external diagnosing apparatus, and sends the corrected plurality of threshold values to the plurality of external diagnosing apparatus. Consequently, the number of samples for setting a plurality of threshold values can be increased, thus making it possible to set the plurality of threshold values more appropriately.

A vehicle diagnosing method according to the present invention performs data communications with an electronic control unit installed on a diagnostic target vehicle and an external diagnosing apparatus, to thereby acquire detected values from sensors on the diagnostic target vehicle in the external diagnosing apparatus, and diagnoses the diagnostic target vehicle. The vehicle diagnosing method comprises the steps of setting a plurality of threshold values depending on a degree of aging of the diagnostic target vehicle and a degree of deterioration of the diagnostic target vehicle with respect to a diagnostic target item, and comparing the set plurality of threshold values with the detected values acquired from the diagnostic target vehicle in order to judge the degree of deterioration of the diagnostic target vehicle with respect to the diagnostic target item.

### BRIEF DESCRIPTION OF DRAWINGS

FIG. 1 is a block diagram showing a general configuration of a vehicle diagnosing system according to an embodiment of the present invention;

FIG. 2 is a block diagram showing a general configuration of an external diagnosing apparatus and a vehicle as a diagnostic target;

FIG. 3 is a view showing by way of example a displayed screen for selecting diagnostic functions according to the embodiment;

FIG. 4 is a first flowchart of a processing sequence of the external diagnosing apparatus;

FIG. 5 is a second flowchart of a processing sequence of the external diagnosing apparatus;

FIG. 6 is a view showing by way of example a displayed screen on which an input box for inputting vehicular information is displayed;

FIG. 7 is a view showing by way of example a displayed visual display screen used while a deterioration diagnosing function is being performed;

FIG. 8 is a view showing by way of example a displayed list display screen used while the deterioration diagnosing function is being performed;

FIG. 9 is a flowchart of a sequence for setting a deterioration judgment threshold value (details of step S13 of FIG. 5);

FIG. 10 is a diagram showing a measured threshold value identifying map, which stipulates a relationship between combinations of numbers of years in use and traveled distances, and measured threshold value flags;

FIG. 11 is a diagram showing a deterioration judgment threshold value identifying map, which stipulates a relationship between designed maximum tolerances or measured threshold value flags and deterioration judgment threshold values for items as diagnostic targets; and

FIG. 12 is a flowchart of a sequence for comparing acquired target data and deterioration judgment threshold values (details of S14 in FIG. 5).

### DESCRIPTION OF EMBODIMENTS

### A. Embodiment

### [1. Configuration]

### (1-1. Overall Configuration)

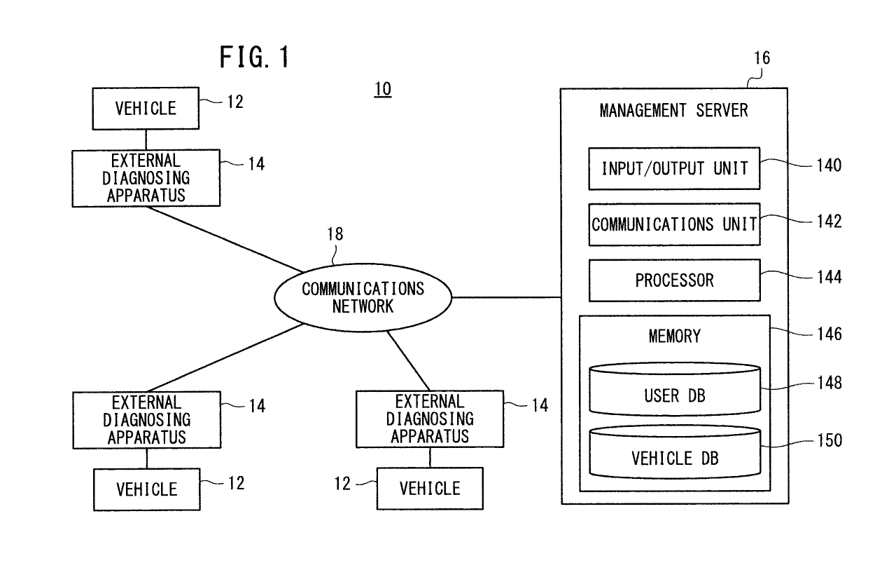

FIG. 1 is a block diagram showing a general configuration of a vehicle diagnosing system 10 (hereinafter also referred to as a “system 10”) according to an embodiment of the present invention. The system 10 is provided with a plurality of vehicles 12 (a motorcycle according to the present embodiment, hereinafter referred to as a “vehicle 12”), which serve as diagnostic targets, a plurality of external diagnosing apparatus 14 installed in repair shops, vehicle dealers, or the like, for carrying out a fault diagnosis on the vehicles 12 from outside of the vehicles 12, and a management server 16 (hereinafter also referred to as a “server 16”), which is installed in a management center. According to the present embodiment, each of the external diagnosing apparatus 14 and the server are capable of communicating with each other via a communications network 18.

### (1-2. Vehicle 12)

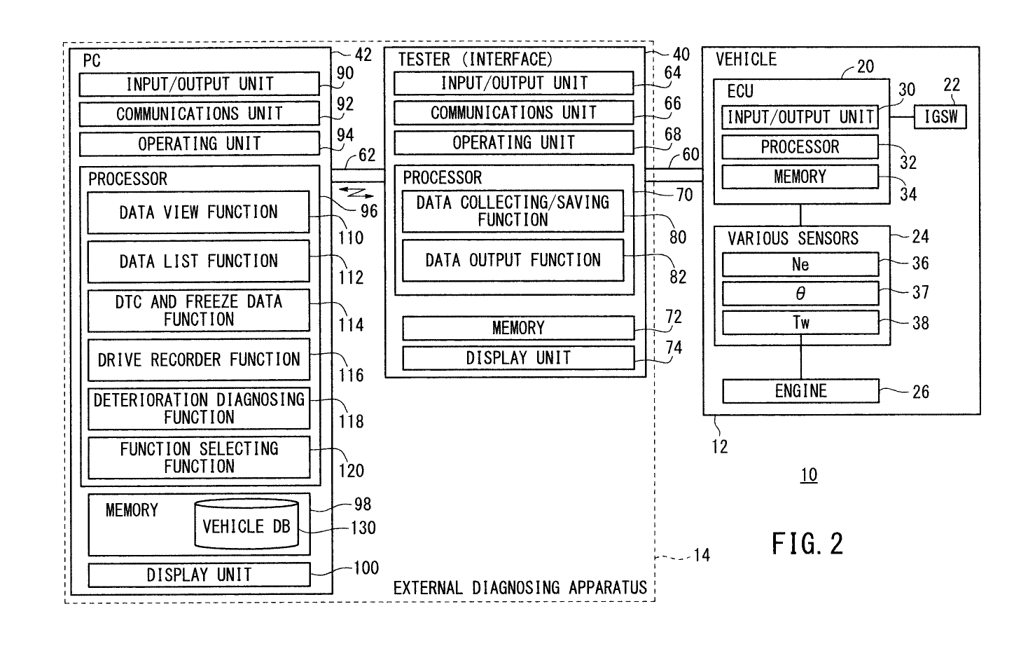

FIG. 2 is a block diagram showing a general configuration of a vehicle 12 and an external diagnosing apparatus 14. The vehicle 12 has an electronic control unit 20 (hereinafter referred to as an “ECU 20”), an ignition switch 22 (hereinafter referred to as an “IGSW 22”) for controlling ON and OFF states of the ECU 20, and various sensors 24. The vehicle 12 is arranged such that vehicular data from the ECU 20 and the various sensors 24 can be read out from the vehicle 12 through a non-illustrated data link connector.

The ECU 20 serves to control an engine 26, a transmission (not shown), and a brake (not shown), etc., and as shown in FIG. 2, has an input/output unit 30, a processor 32, and a memory 34.

The various sensors 24 include an engine rotational speed sensor 36 for detecting the rotational speed (rpm) of the engine 26 (hereinafter referred to as an “engine rotational speed Ne”), a throttle sensor 37 for detecting the operated angle (hereinafter referred to as an “operated angle θ”) of a non-illustrated throttle grip, and a coolant temperature sensor 38 for detecting the temperature of a coolant (hereinafter referred to as a “coolant temperature Tw”) [° C.] of the engine 26.

According to the present embodiment, the engine 26 is a gasoline engine, and the vehicle 12 is a gasoline vehicle. As described later, the vehicle 12 may alternatively be a vehicle such as a diesel engine vehicle, an electric automobile, a hybrid vehicle, or the like. Although the vehicle 12 according to the present embodiment is illustrated as a motorcycle, the vehicle 12 may be a three-wheeled vehicle, a four-wheeled vehicle, a six-wheeled vehicle, or the like.

### (1-3. External Diagnosing Apparatus 14)

### (1-3-1. General)

The external diagnosing apparatus 14 (hereinafter also referred to as a “diagnosing apparatus 14”) is provided with a tester 40 and a personal computer 42 (hereinafter referred to as a “PC 42”). The diagnosing apparatus 14 is capable of carrying out various diagnoses (including a physical checkup) on the vehicle 12.

### (1-3-2. Tester 40)

The tester 40 is used in various diagnoses (examinations) as a communications interface for connecting to the ECU 20 of the vehicle 12 at a dealer, a repair shop, or the like, and for reading data of the vehicle 12. Although the tester 40 has a processing capability and a storage capacity smaller than those of the PC 42, the tester 40 is smaller in size and can easily be carried around. Using the various data (sensor detected values) read from the vehicle 12, the tester 40 itself is capable of carrying out various diagnoses (or examinations) on the vehicle 12, and also is capable of saving and reading various data and thereafter sending the data to the PC 42.

As shown in FIG. 2, the tester 40 has a first cable 60 for connecting to the ECU 20 of the vehicle 12 through a non-illustrated data link connector, a second cable 62 for connecting to the PC 42, an input/output unit 64 connected to the first cable 60 and the second cable 62 for inputting and outputting signals, a communications unit 66 for performing wireless communications with the PC 42, an operating unit 68, a processor 70 for controlling various components of the tester 40, a memory 72 for storing data and various programs including a control program used by the processor 70, and a display unit 74.

The operating unit 68 has operating buttons, etc., for sending output commands (quasi signals) to the ECU 20 of the vehicle 12 or to the various sensors 24 as necessary.

The processor 70 has a data collecting/saving function 80 and a data output function 82. The data collecting/saving function 80 is a function to collect various data (sensor output values) from the vehicle 12 through the ECU 20 and to save the collected various data in the memory 72. The data output function 82 is a function to output the various data saved in the memory 72 to the PC 42.

The display unit 74 displays data that are read from the ECU 20 in various modes such as a monitor display mode.

The first cable 60 may be replaced with a wireless communications function. The tester 40 and the PC may communicate with each other in a wired communications mode via the second cable 62 and in a wireless communications mode via the communications unit 66. However, the tester 40 and the PC 42 may communicate with each other in either one of the wired communications mode and the wireless communications mode.

### (1-3-3. PC 42)

The PC 42 has an input/output unit 90 coupled to the second cable 62 for inputting and outputting signals, a communications unit 92 for performing wireless communications with the tester 40, an operating unit 94 including a keyboard, a mouse, a touch pad, etc., not shown, a processor 96 for controlling various components of the PC 42 and carrying out various diagnoses, a memory 98 for storing data and various programs including a control program and a diagnostic program used by the processor 96, and a display unit 100 for displaying various items of information. The PC 42 may be in the form of a commercially available laptop personal computer as a hardware configuration, for example.

The processor 96 has a data view function 110, a data list function 112, a DTC and freeze data function 114 (hereinafter also referred to as a “DTC function 114”), a drive recorder function 116, a deterioration diagnosing function 118, and a function selecting function 120.

The data view function 110 is a function to read, display, and edit data stored in the memory 98 of the PC 42. The data list function 112 is a function to produce a list of data that can be acquired from the vehicle 12, and to display the list.

The DTC function 114 is a function to display and edit fault codes (DTC: Diagnostic Trouble Codes) and freeze data. When the ECU 20 detects a fault of the vehicle 12, a DTC is saved as information indicating details of the fault in the memory 34. The DTC function 114 of the PC 42 is capable of displaying and editing a DTC that is read from the ECU 20 as a result of a present diagnosis, and a DTC that was read from the ECU 20 in the past. The freeze data represents a sensor detected value in relation to the fault at the time that the fault occurred (at the time that the DTC was saved).

If the vehicle 12 is provided with a drive recorder (not shown), the drive recorder function 116 is a function to play back and edit data of the drive recorder.

The deterioration diagnosing function 118 is a function to diagnose the physical state, i.e., an operating state (including a deterioration state), of the vehicle 12 at the present time. More specifically, the deterioration diagnosing function 118 diagnoses the vehicle 12 to determine whether or not the sensor detected values are abnormal, i.e., whether or not the sensors have excessively deteriorated. The sensor detected values represent data (operating parameters) indicating operating states of various components of the vehicle 12, including not only output values from the individual sensors included in the various sensors 24, but also values calculated by the ECU or a non-illustrated processor based on output values from the individual sensors.

Items to be diagnosed as diagnostic targets by the deterioration diagnosing function 118 may include, for example, an engine rotational speed Ne, a throttle sensor voltage, a coolant temperature sensor voltage, an intake temperature sensor voltage, an intake pressure sensor voltage, an atmospheric pressure sensor voltage, a fuel injection quantity, an ignition timing, an idling air control valve opening, a battery voltage, and an oil temperature sensor voltage.

The function selecting function 120 is a function to select which of the above functions 110, 112, 114, 116, 118 will be performed according to an operating action taken by the user.

The memory 98 is provided with a vehicle database 130 (hereinafter referred to as a “vehicle DB 130”). The vehicle DB 130 stores information including a vehicle identification number (hereinafter referred to as a “VIN”), a vehicle type name, a model year, a destination, a model, identifying information of the ECU 20 (hereinafter referred to as an “ECU ID”), DTC, freeze data, and a deterioration judgment threshold value, etc.

For diagnosing the vehicle 12 with the PC 42, the first cable 60 of the tester 40 is connected to a non-illustrated connector (data link connector) of the vehicle 12. The ECU 20 and the PC 42 are brought into a state of being capable of communicating with each other, using the second cable 62 or the communications units 66, 92. Thereafter, in response to an operating action taken by the user on the operating unit 94 of the PC 42, the PC 42 performs a diagnosis (including a physical checkup) on the vehicle 12.

### (1-4. Server 16)

As shown in FIG. 1, the server 16 includes an input/output unit 140, a communications unit 142, a processor 144, and a memory 146. The memory 146 has a user database 148 (hereinafter referred to as a “user DB 148”) and a vehicle database 150 (hereinafter referred to as a “vehicle DB 150”).

The user DB 148 contains information concerning the user. Such information concerning the user includes a name, a gender, a date of birth (age), a family makeup, a purpose for which the vehicle is used, etc.

The vehicle DB 150 contains information concerning the vehicle. Such information concerning the vehicle includes the VIN, a type name, a vehicle type name, a model year, a destination, a model, identifying information of the ECU 20 (ECU ID), DTC, freeze data, and a deterioration judgment threshold value, etc.

### [2. Displayed Screens on PC 42]

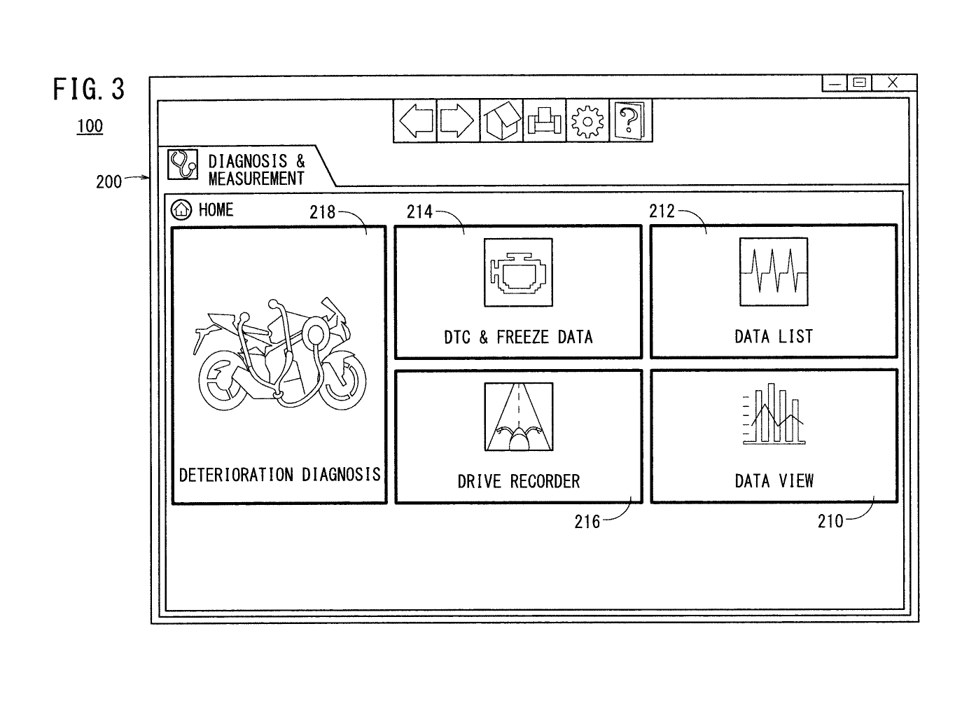

As described above, the PC 42 has the data view function 110, the data list function 112, the DTC function 114, the drive recorder function 116, and the deterioration diagnosing function 118, and is capable of performing various diagnoses using the functions 110, 112, 114, 116, 118. In order for the diagnostic functions 110, 112, 114, 116, 118 to be selectable one at a time, as shown in FIG. 3, the PC 42 (function selecting function 120) displays a screen (hereinafter referred to as a “diagnostic function selecting screen 200”, a “function selecting screen 200”, or a “screen 200”) on the display unit 100. FIG. 3 shows by way of example the screen 200 for selecting the diagnostic functions 110, 112, 114, 116, 118.

As shown in FIG. 3, the diagnostic function selecting screen 200 includes five diagnostic function selecting buttons for reading data from the ECU 20, i.e., a data view function performing button 210 (hereinafter referred to as a “data view button 210”), a data list function performing button 212 (hereinafter referred to as a “data list button 212”), a DTC and freeze data function performing button 214 (hereinafter referred to as a “DTC button 214”), a drive recorder function performing button 216 (hereinafter referred to as a “drive recorder button 216”), and a deterioration diagnosing function performing button 218 (hereinafter referred to as a “deterioration diagnosing button 218”).

If the data view button 210 is selected by the user through the operating unit 94 of the PC 42, the data view function 110 is performed. If the data list button 212 is selected by the user through the operating unit 94, the data list function 112 is performed. If the DTC button 214 is selected by the user through the operating unit 94, the DTC function 114 is performed. If the drive recorder button 216 is selected by the user through the operating unit 94, the drive recorder function 116 is performed. If the deterioration diagnosing button 218 is selected by the user through the operating unit 94, the deterioration diagnosing function 118 is performed.

According to the present embodiment, if there is a diagnostic function that is permitted to be performed at the present time, the function selecting function 120 displays the selecting button corresponding to the diagnostic function in an active state (selectable state). If there is a diagnostic function that is not permitted to be performed at the present time, the function selecting function 120 displays the selecting button corresponding to the diagnostic function in an inactive state (unselectable state). According to the present embodiment, furthermore, the function selecting function 120 displays the inactive selecting button in a pale, blurred fashion compared with the active selecting button, so that the user is capable of distinguishing the active state and the inactive state from each other.

### [3. Processing Operations of External Diagnosing Apparatus 14]

### (3-1. Overall Flow)

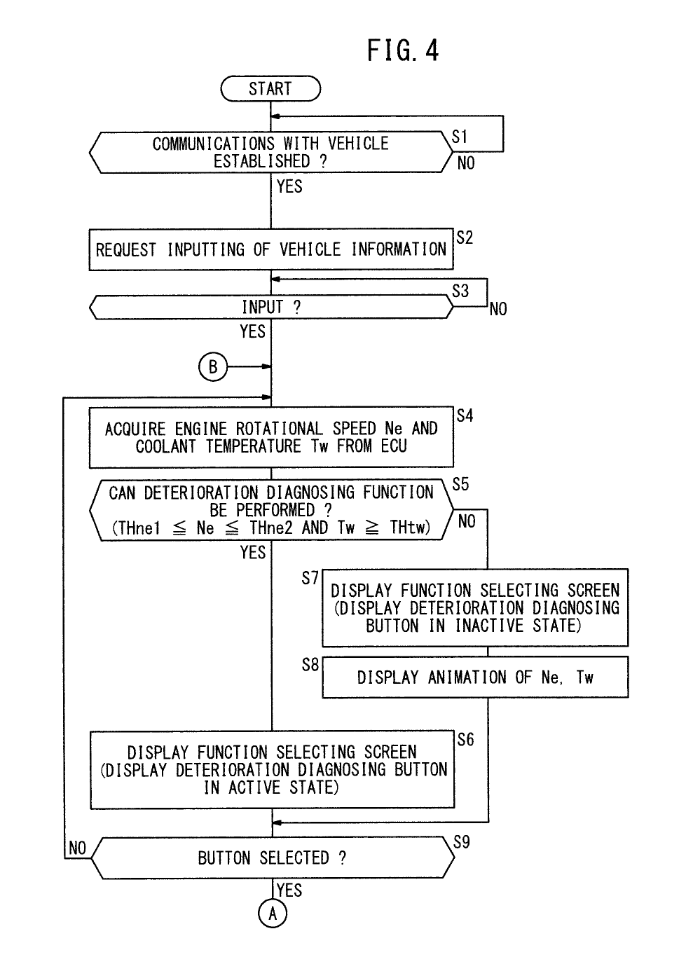

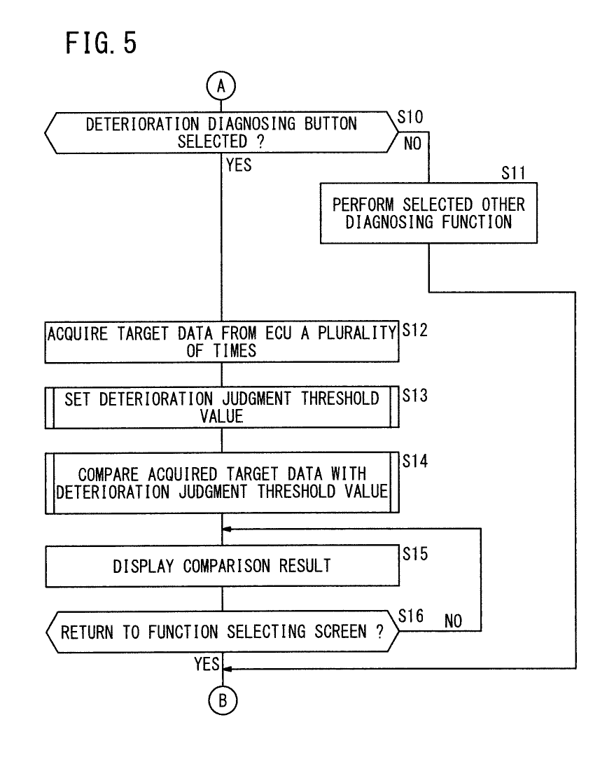

FIGS. 4 and 5 are first and second flowcharts of a processing sequence of the external diagnosing apparatus 14. For starting the processing sequence shown in FIGS. 4 and 5, the user (technician) turns on the PC 42. For performing a physical check (deterioration diagnosis), the user turns on the IGSW 22 of the vehicle 12, so as to keep the ECU 20 and the tester 40 connected to each other and also to keep the tester 40 and the PC 42 connected to each other while the tester 40 and the PC 42 are capable of communicating with each other. As described later, at least prior to step S4 (FIG. 4), a non-illustrated starter motor is energized by the IGSW 22 in order to start up the engine 26.

In step S1, the PC 42 (function selecting function 120) judges whether or not communications have been established between the PC 42 and the vehicle 12 via the tester 40. If communications have not been established (step S1: NO), then step S1 is looped.

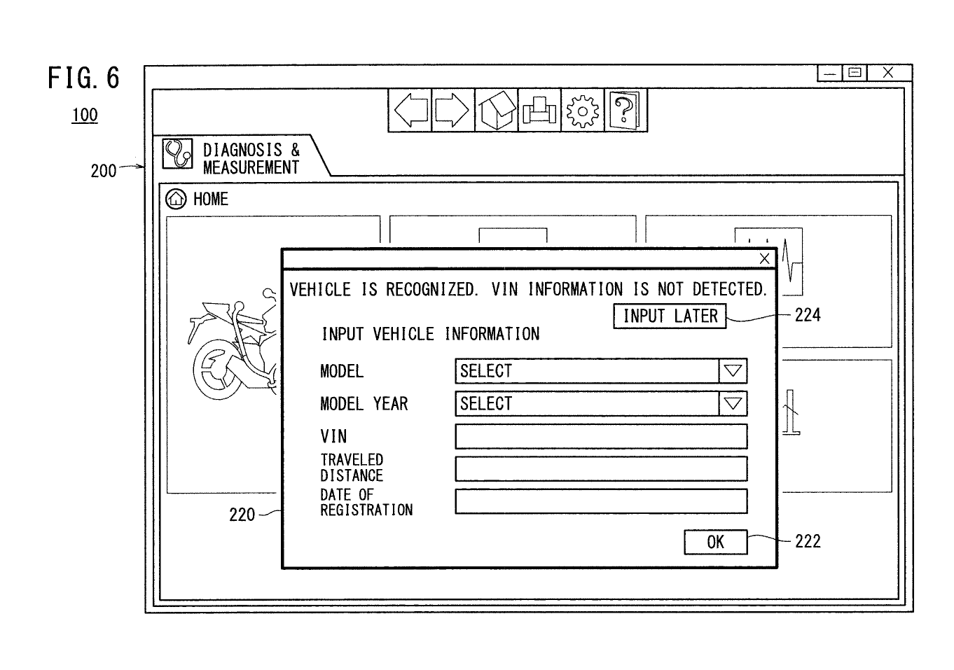

If communications have been established with the vehicle 12 (step S1: YES), then in step S2, the PC 42 (function selecting function 120) requests the user to input vehicle information. More specifically, the PC 42 (function selecting function 120) displays an input box 220, as shown in FIG. 6, on the display unit 100.

In step S3, the PC 42 (function selecting function 120) judges whether or not vehicle information has been input. More specifically, the PC 42 (function selecting function 120) judges whether or not vehicle information has been input in the input box 220 and an OK button 222 has been clicked on. If vehicle information has not been input (step S3: NO), then step S3 is looped.

If the user inputs a message for delaying input of vehicle information at the time of step S3, or more specifically, if the user selects a button 224 marked with “INPUT LATER” (hereinafter referred to as a “delay button 224”) in the input box 220 shown in FIG. 6, the PC 42 (function selecting function 120) may display on the display unit 100 a function selecting screen 200, in which four of the five diagnostic function selecting buttons other than the deterioration diagnosing button 218 (i.e., the data view button 210, the data list button 212, the DTC button 214, and the drive recorder button 216) are displayed in an active state. In this case, a physical check (deterioration diagnosis) is not permitted, whereas the other functions are permitted until the vehicle information is input.

If the OK button 222 is clicked on when required vehicle information has not been input partially or wholly, then an error message may be displayed, and thereafter, the input box 220 may be displayed again.

If vehicle information has been input in step S3 (step S3: YES), then in step S4, the PC 42 (function selecting function 120) acquires an engine rotational speed Ne [rpm] and a coolant temperature Tw [° C.] of the engine 26 from the ECU 20 via the tester 40. More specifically, the PC 42 (function selecting function 120) sends an output command for outputting an engine rotational speed Ne and a coolant temperature Tw to the ECU 20 via the tester 40. In response to the output command, the ECU 20 acquires detected values from the engine rotational speed sensor 36 and the coolant temperature sensor 38, which are included among the various sensors 24, and sends the acquired detected values to the PC 42 via the tester 40.

In step S5, the PC 42 (function selecting function 120) judges whether or not the PC 42 is capable of performing the deterioration diagnosing function 118. More specifically, the PC 42 judges whether or not the engine rotational speed Ne acquired in step S4 falls within a range from a first engine rotational speed threshold value THne1 (hereinafter referred to as a “threshold value THne1”) or greater to a second engine rotational speed threshold value THne2 (hereinafter referred to as a “threshold value THne2”) or less. Between the threshold values THne1 and THne2, a range of engine rotational speeds Ne is defined and stored in the memory 98, which can be taken by the engine in an idling mode after the engine has warmed up. In addition, the PC 42 judges whether or not the coolant temperature Tw acquired in step S4 is equal to or greater than a coolant temperature threshold value THtw (hereinafter referred to as a “threshold value THtw”). The threshold value THtw represents a coolant temperature Tw that is stored in the memory 98, which can be taken by the coolant after the engine has warmed up.

If the PC 42 is capable of performing the deterioration diagnosing function 118 (step S5: YES), then in step S6, the PC 42 (function selecting function 120) displays the function selecting screen 200 in which all five of the diagnostic function selecting buttons 210, 212, 214, 216, 218 including the deterioration diagnosing button 218 are active (see FIG. 3).

If the PC 42 is incapable of performing the deterioration diagnosing function 118 (step S5: NO), then in step S7, the PC 42 (function selecting function 120) displays the function selecting screen 200 in which the deterioration diagnosing button 218 is inactive, whereas the other selecting buttons 210, 212, 214, 216 are active. Then, in step S8, the PC 42 (function selecting function 120) displays, in the area of the deterioration diagnosing button 218 in the function selecting screen 200, an animation of the engine rotational speed Ne and the coolant temperature Tw, together with a message indicating that more time is needed until the deterioration diagnosis can be performed.

After step S6 or step S8, in step S9, the PC 42 (function selecting function 120) judges whether or not any one of the five selecting buttons 210, 212, 214, 216, 218 has been selected. If none of the five selecting buttons 210, 212, 214, 216, 218 has been selected (step S9: NO), control returns to step S4. If any one of the five selecting buttons 210, 212, 214, 216, 218 has been selected (step S9: YES), control proceeds to step S10 shown in FIG. 5.

In step S10 of FIG. 5, the PC 42 (function selecting function 120) judges whether or not the selected button is the deterioration diagnosing button 218. If the selected button is not the deterioration diagnosing button 218 (step S10: NO), then in step S11, the PC 42 (function selecting function 120) performs the function corresponding to the selected button. For example, if the selected button is the DTC button 214, the PC 42 (function selecting function 120) performs the DTC function 114 corresponding to the DTC button 214 by reading the DTC data recorded in the ECU 20. The PC 42 (DTC function 114) also displays the read DTC data on the display unit 100.

If the deterioration diagnosing button 218 is selected (step S10: YES), then in steps S12 through S16, the PC 42 performs the deterioration diagnosing function 118.

In step S12, the PC 42 (deterioration diagnosing function 118) acquires data on the basis of which each diagnostic target item (hereinafter referred to as “target data”) is diagnosed. More specifically, the PC 42 (deterioration diagnosing function 118) sends an output command for outputting target data to the ECU 20 via the tester 40. In response to the output command, the ECU 20 acquires the target data contained in the various sensors 24, and sends the acquired target data to the PC 42 via the tester 40. According to the present embodiment, each of the target data is acquired a plurality of times. For example, if the target data represent the engine rotational speed Ne, the engine rotational speed Ne is acquired a plurality of times.

In step S13, the PC 42 (deterioration diagnosing function 118) sets a deterioration judgment threshold value. The deterioration judgment threshold value is a threshold value that is set for each target data for judging a deterioration state of a diagnostic target item.

A deterioration state of a diagnostic target item implies a deterioration state of the diagnostic target vehicle 12 with respect to the diagnostic target item. As a result, a deterioration state of a diagnostic target item may imply a deterioration state of a component (diagnostic-target component) in relation to the diagnostic target item.

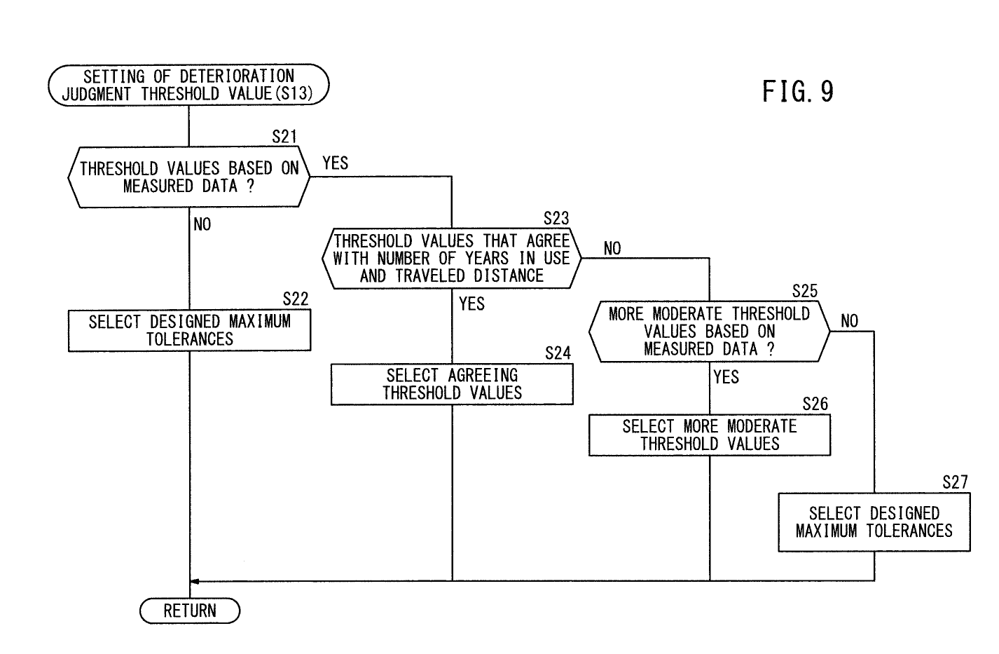

A deterioration judgment threshold value is set as at least one of an upper limit value and a lower limit value for each diagnostic target item. A process of setting the deterioration judgment threshold value will be described later with reference to FIGS. 9 through 11.

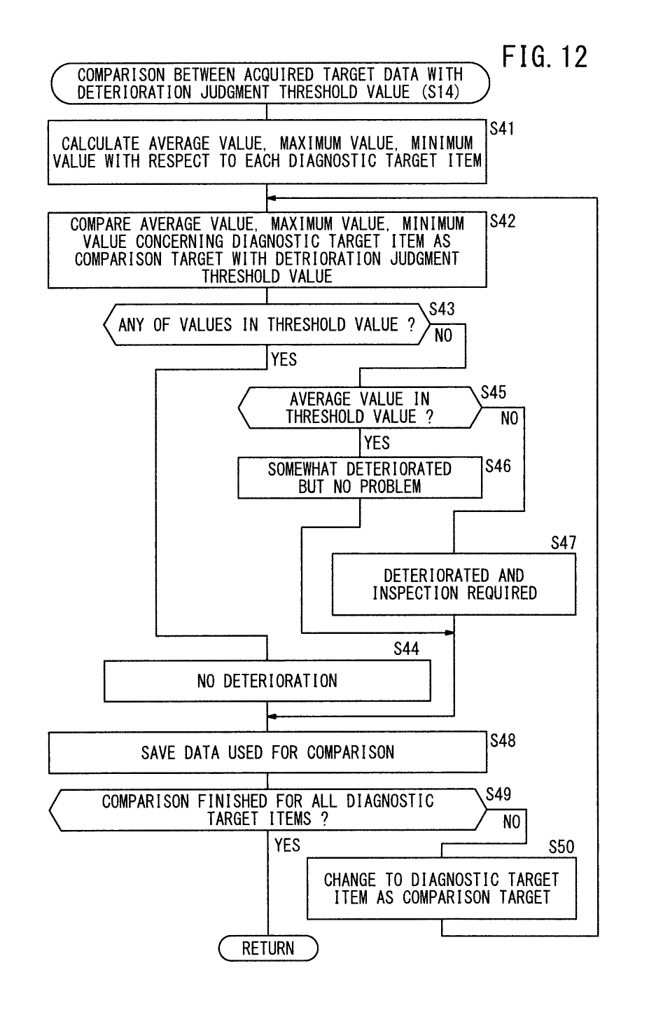

In step S14, the PC 42 (deterioration diagnosing function 118) compares the acquired target data with the deterioration judgment threshold value. Details of the comparing process will be described later with reference to FIG. 12.

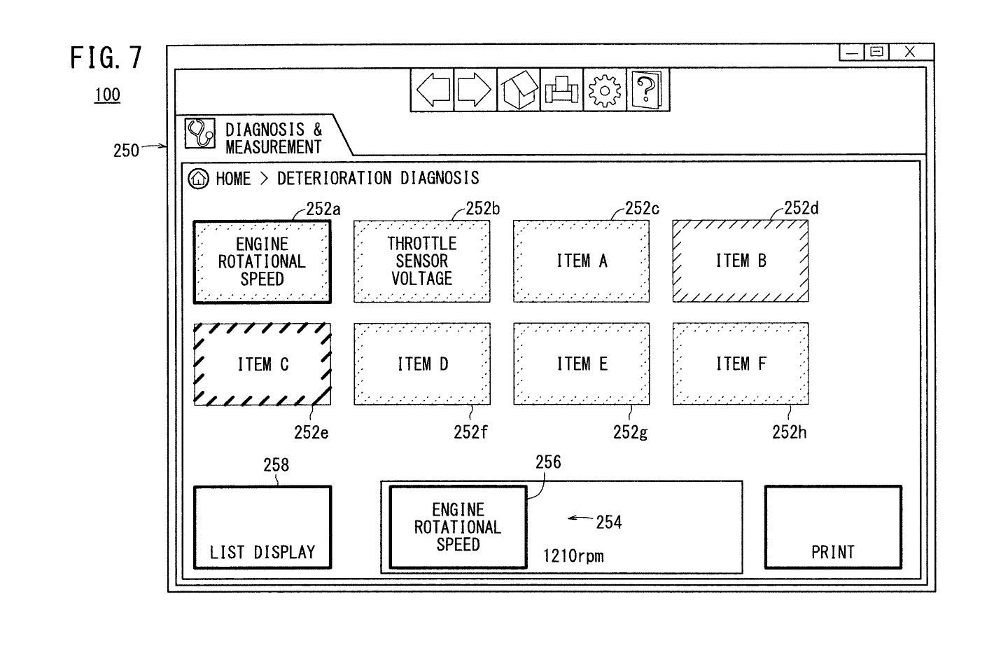

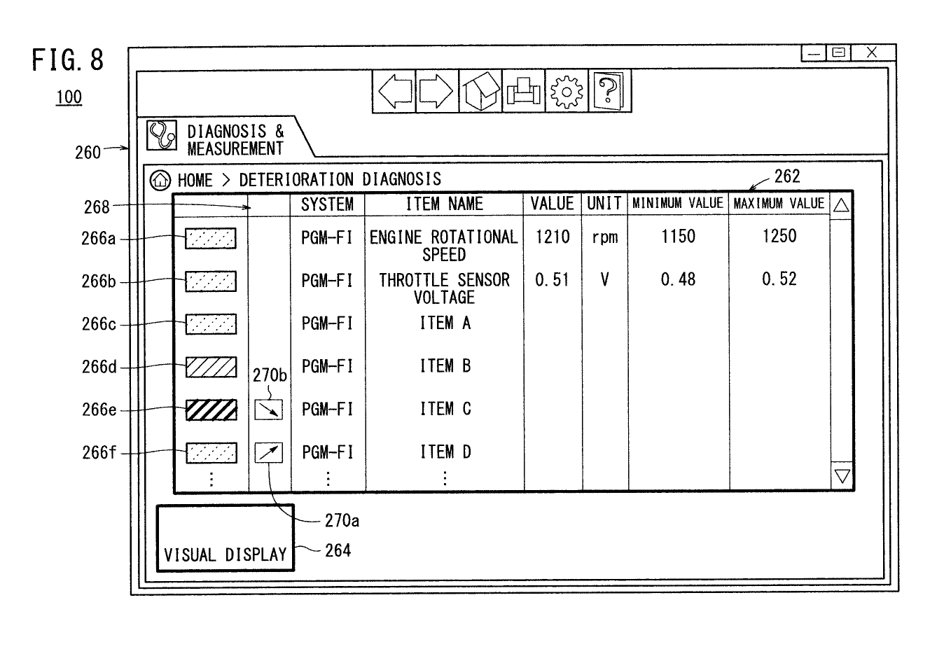

In step S15, the PC 42 (deterioration diagnosing function 118) displays on the display unit 100 the result of a comparison between the target data and the deterioration judgment threshold value. More specifically, the PC 42 (deterioration diagnosing function 118) displays an initial screen for the comparison result. As shown in FIG. 7, the initial screen comprises a screen (hereinafter referred to as a “visual display screen 250”) that contains items (names) as diagnostic targets surrounded by frames. As described later, the user can switch between the visual display screen 250 and a list display screen 260 (FIG. 8), etc., while the deterioration diagnosing function 118 is being performed.

FIG. 7 is a view showing by way of example the displayed visual display screen 250. As shown in FIG. 7, the visual display screen 250 contains a plurality of displays 252a through 252h representing items as diagnostic targets surrounded by frames (hereinafter referred to as “framed displays 252a through 252h”, and referred to collectively as “framed displays 252”).

If any one of the framed displays 252 is simply selected by being clicked on once by the user through the operating unit 94, then the selected framed display 252 is displayed in a bold frame. (In FIG. 7, the framed display 252a representing the item “ENGINE ROTATIONAL SPEED” is displayed as the diagnostic target in a bold frame.) A framed display 256, which corresponds to the simply selected framed display 252, is displayed together with a numerical value thereof in a display area 254 in a lower portion of the screen 250. (In FIG. 7, the framed display 256 representing the item “ENGINE ROTATIONAL SPEED” is displayed as the diagnostic target.)

If any one of the framed displays 252 is selected by being clicked on twice by the user through the operating unit 94, then a screen (not shown) representing details of the selected framed display 252 is displayed.

The framed displays 252a through 252h are displayed in different colors depending on the degrees of deterioration of the items that serve as the diagnostic targets. For example, the framed displays 252a through 252c, 252f through 252h, which represent items that are free of deterioration, are displayed in blue, the framed display 252d, which represents an item that is somewhat deteriorated but has no problem, is displayed in yellow, and the framed display 252e, which represents an item that is deteriorated and needs to be inspected, is displayed in red. A process of judging a degree of deterioration will be described later with reference to FIG. 12.

The visual display screen 250 also includes a display switching button 258. The display switching button 258 is a button for switching from the visual display screen 250 to the list display screen 260.

FIG. 8 is a view showing by way of example a list display screen 260 that is displayed. The list display screen 260 includes degree-of-deterioration display fields 266a through 266f, a deterioration progress status display field 268, and a list display field 262 (hereinafter also referred to as a “display field 262”), which displays a list of system names, item names, sensor detected values, units, minimum values, and maximum values for respective items as diagnostic targets. If a line corresponding to a diagnostic target item in the display field 262 is simply selected by being clicked on once by the user through the operating unit 94, then the color of the line is changed (inverted) and displayed. If any one of the lines is selected by being clicked on twice by the user through the operating unit 94, then a screen (not shown), which represents details of the diagnostic target item corresponding to the selected line, is displayed.

The degree-of-deterioration display fields 266a through 266f are displayed in different colors depending on the degrees of deterioration of the items that serve as diagnostic targets. The degree-of-deterioration display fields 266a through 266f are displayed in the same colors as the above-described framed displays 252a through 252h. For example, the display fields 266a through 266c, 266f, which represent items that are free of deterioration, are displayed in blue, the display field 266d, which represents an item that is somewhat deteriorated but has no problem, is displayed in yellow, and the display field 266e, which represents an item that is deteriorated and needs to be inspected, is displayed in red. The process of judging a degree of deterioration will be described later with reference to FIG. 12. The degree-of-deterioration display fields 266a through 266f may include icons that symbolize the items that serve as the diagnostic targets.

The deterioration progress status display field 268 is a field that indicates the state of progress of the degrees of deterioration. More specifically, if the vehicle DB 130 stores past diagnostic results of the vehicle 12 as a diagnostic target, then the deterioration progress status display field 268 indicates results of comparison between past diagnostic results and present diagnostic results. For example, if the present diagnostic result of the diagnostic target item is better than the previous diagnostic result thereof, the deterioration progress status display field 268 displays an arrow 270a that points upwardly to the right, whereas if the present diagnostic result of the diagnostic target item is worse than the previous diagnostic result thereof, the deterioration progress status display field 268 displays an arrow 270b that points downwardly to the right.

The list display screen 260 also includes a display switching button 264. The display switching button 264 is a button for switching from the list display screen 260 to the visual display screen 250.

According to the present embodiment, as described above, diagnostic target items may include, for example, an engine rotational speed Ne, a throttle sensor voltage, a coolant temperature sensor voltage, an intake temperature sensor voltage, an intake pressure sensor voltage, an atmospheric pressure sensor voltage, a fuel injection quantity, an ignition timing, an idling air control valve opening, a battery voltage, and an oil temperature sensor voltage.

Referring back to FIG. 5, in step S16, the PC 42 (deterioration diagnosing function 118) judges whether or not to return to the function selecting screen 200 (FIG. 3). More specifically, the screen (not shown) for displaying the comparison result contains a button for returning to the function selecting screen 200, and the PC (deterioration diagnosing function 118) judges whether or not the button has been selected. If the screen for displaying the comparison result is not to return to the function selecting screen 200 (step S16: NO), then control returns to step S15. If the screen for displaying the comparison result is to return to the function selecting screen 200 (step S16: YES), then control returns to step S4 of FIG. 4.

### (3-2. Setting of Deterioration Judgment Threshold Value)

### (3-2-1. Concept)

In step S13 of FIG. 5, a deterioration judgment threshold value is set on the basis of the following concept. For designing a vehicle, the designer sets designed maximum tolerances for the performance of respective components in view of aging.

Since the designed maximum tolerance for a component is set in view of aging, the measured data (hereinafter referred to as “actual value data”) of the performance of the component at the time of inspection upon shipment from the factory falls within a range narrower than the designed maximum tolerance. Incidentally, any components whose actual value data do not fall within the ranges of their designed maximum tolerances are not shipped from the factory.

If aging is on the premise that such aging takes place over a plurality of years (e.g., several tens of years), then measured data of the respective diagnostic target items depending on the number of years in which the vehicle has been in use and the distance that the vehicle has traveled fall within the ranges of their designed maximum tolerances, but tend to vary greater than the actual data at the time of inspection upon shipment from the factory. If aging data of a certain diagnostic target item do not fall within the range of a designed maximum tolerance thereof, a sensor related to the diagnostic target item is judged as faulty.

According to the present embodiment, a deterioration judgment threshold value is set on the basis of the number of years in use and the traveled distance of the diagnostic target vehicle 12, and the degree of deterioration of the diagnostic target vehicle 12 is diagnosed by observing whether or not the degree of deterioration of each of the diagnostic target items of the diagnostic target vehicle 12 exceeds the deterioration judgment threshold value. Alternatively, if a component has already been replaced, then the number of years in use and the traveled distance of the target vehicle 12 after replacement of the component may be used instead of the number of years in use and the traveled distance of the diagnostic target vehicle 12.

(3-2-2. Flow of Setting of Deterioration Judgment Threshold Value when Judging a Degree of Deterioration)

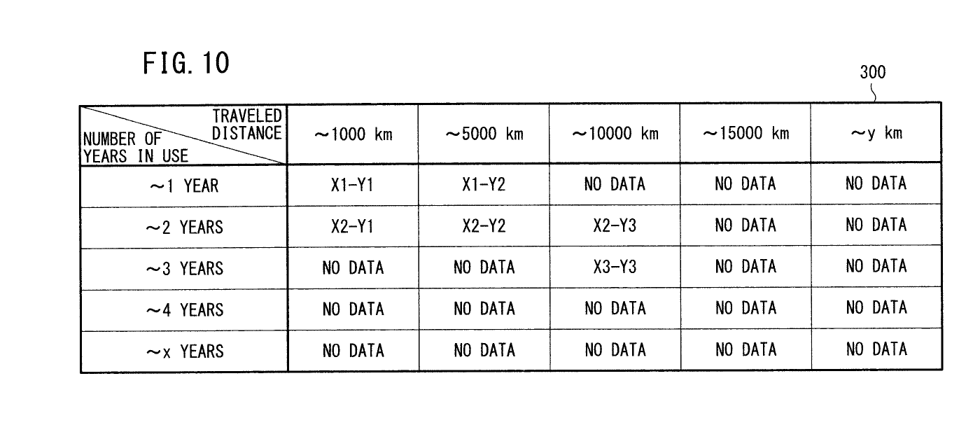

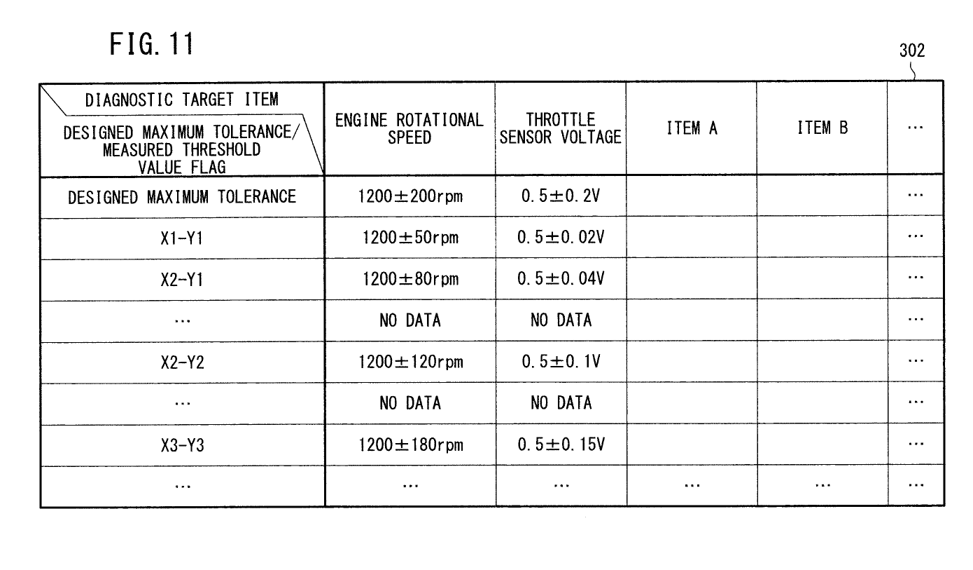

FIG. 9 is a flowchart of a sequence for setting a deterioration judgment threshold value (details of step S13 of FIG. 5). FIGS. 10 and 11 show maps for use in setting a deterioration judgment threshold value. More specifically, FIG. 10 is a diagram showing a measured threshold value identifying map 300 (hereinafter referred to as a “map 300”) that stipulates the relationship between combinations of numbers of years in use and traveled distances, and measured threshold value flags. FIG. 11 is a diagram showing a deterioration judgment threshold value identifying map 302 (hereinafter referred to as a “map 302”) that stipulates the relationship between designed maximum tolerances or measured threshold value flags, and deterioration judgment threshold values for respective diagnostic target items.

Prior to performing the sequence shown in FIG. 9, the PC 42 (deterioration diagnosing function 118) updates the maps 300, 302. The maps 300, 302 may be updated by an operating action taken by the user, or may be updated automatically by the PC 42. The maps 300, 302 may be updated immediately before a diagnosis, or may be updated in given periodic cycles (once a day, etc.). Updated data of the maps 300, 302 are downloaded from the vehicle DB 150 of the server 16, and the updated data are saved in the vehicle DB 130 of the PC 42.

In step S21 of FIG. 9, the PC 42 (deterioration diagnosing function 118) judges whether or not there are deterioration judgment threshold values based on measured data for vehicles within the same class (vehicle type, model, or the like) as the diagnostic target vehicle 12. In other words, the PC 42 (deterioration diagnosing function 118) judges whether or not there is a measured threshold value identifying map 300 that can be used on the diagnostic target vehicle 12. Alternatively, the PC 42 (deterioration diagnosing function 118) may judge whether or not measured threshold value flags have been input to the map 300 that can be used on the diagnostic target vehicle 12.

The measured threshold value flags are represented by the characters indicated by “X1-Y1”, “X1-Y2”, etc., in FIG. 10. According to the present embodiment, as shown in FIG. 10, the measured threshold value flags are set at the positions of rows and columns. More specifically, orders along the rows shown in FIG. 10 are indicated by X, whereas orders along the columns are indicated by Y. For example, the measured threshold value flag “X1-Y2” indicates that the value exists on the first row and the second column.

In FIG. 10, a measured threshold value flag “X1-Y1” indicates that the number of years in use is one or less and the traveled distance is 1000 km or less, and includes the measured value data (inspection data at the time of shipment from the factory) referred to above. Measured threshold value flags other than “X1-Y1”, e.g., “X1-Y2”, “X2-Y1”, correspond to the aging data referred to above.

In FIG. 10, “NO DATA” implies that the number of acquired measured data is less than a predetermined value. The predetermined value represents a sufficient value (significant sample count) that is capable of setting a deterioration judgment threshold value based on measured data.

For combinations of the number of years in use and the traveled distances for which measured threshold value flags exist in FIG. 10, deterioration judgment threshold values exist corresponding to the measured threshold value flags, as shown in FIG. 11.

As shown in FIG. 11, the deterioration judgment threshold value identifying map 302 stipulates deterioration judgment threshold values with respect to respective combinations of designed maximum tolerances or measured threshold value flags and diagnostic target items. As can be understood from FIG. 11, the deterioration judgment threshold values provide widest allowable ranges for the designed maximum tolerances. The deterioration judgment threshold values provide wider allowable ranges as the number of years in use becomes greater or the traveled distance becomes longer, i.e., as aging progresses. This is because, as the number of years in use becomes greater or the traveled distance becomes longer, the vehicles tend to vary greatly in performance.

Referring back to FIG. 9, if there are not deterioration judgment threshold values based on measured data for vehicles within the same class (vehicle type, model, or the like) as the diagnostic target vehicle 12 in step S21 (step S21: NO), then the deterioration judgment threshold values available in FIG. 11 are designed maximum tolerances only. Stated otherwise, unlike the map shown in FIG. 10, the measured threshold value identifying map 300 contains “NO DATA” only. In step S22, the PC 42 (deterioration diagnosing function 118) selects, as deterioration judgment threshold values, designed maximum tolerances for the respective diagnostic target items.

On the other hand, in step S21, if deterioration judgment threshold values exist based on measured data for vehicles within the same class (vehicle type, model, or the like) as the diagnostic target vehicle 12 (step S21: YES), then in step S23, the PC 42 (deterioration diagnosing function 118) judges whether or not deterioration judgment threshold values exist that are in agreement with the number of years in use and the traveled distance of the diagnostic target vehicle 12. In FIG. 10, if the number of years in use is 1.5 (and up to 2) and the traveled distance is 3000 km (and up to 5000 km), then since a measured threshold value flag “X2-Y2” exists therefor, deterioration judgment threshold values also exist. However, if the number of years in use is 2.5 (and up to 3) and the traveled distance is 3000 km (and up to 5000 km), then since there is a state of “NO DATA”, deterioration judgment threshold values do not exist.

If deterioration judgment threshold values exist that are in agreement with the number of years in use and the traveled distance of the diagnostic target vehicle 12 (step S23: YES), then in step S24, the PC 42 (deterioration diagnosing function 118) selects the agreeing deterioration judgment threshold values. For example, if the number of years in use is 1.5 (and up to 2) and the traveled distance is 3000 km (and up to 5000 km), then the PC 42 (deterioration diagnosing function 118) reads deterioration judgment threshold values corresponding to the measured threshold value flag “X2-Y2” from the deterioration judgment threshold value identifying map 302, and uses the read deterioration judgment threshold values.

If deterioration judgment threshold values do not exist that are in agreement with the number of years in use and the traveled distance of the diagnostic target vehicle (step S23: NO), then in step S25, the PC 42 (deterioration diagnosing function 118) judges whether or not there are more moderate deterioration judgment threshold values based on the measured data. The term “more moderate deterioration judgment threshold values” refers to judgment threshold values corresponding to a greater number of years in use or corresponding to a longer traveled distance.

For example, if the number of years in use is 0.5 (and up to 1) and the traveled distance is 6000 km (and up to 10000 km) in FIG. 10, then “NO DATA” exists within the map 300. However, if the number of years in use is greater (up to 2), then a measured threshold value flag “X2-Y3” exists when the traveled distance is “up to 10000 km”. Thus, since the number of years in use becomes greater, the deterioration judgment threshold values provide a wider (more moderate) range.

If the number of years in use is 2.5 (and up to 3) and the traveled distance is 4000 km (and up to 5000 km), then “NO DATA” exists within the map 300. However, if the traveled distance is greater (up to 10000 km), then a measured threshold value flag “X3-Y3” exists when the number of years in use is “up to 3”. Thus, since the traveled distance becomes greater, the deterioration judgment threshold values provide a wider (more moderate) range.

According to the present embodiment, a judgment is made as to whether or not there are more moderate (longer) deterioration judgment threshold values first with respect to the traveled distance. If there are no corresponding deterioration judgment threshold values, then a judgment is made as to whether or not there are more moderate (longer) deterioration judgment threshold values with respect to the number of years in use. A judgment may be made as to whether or not there are more moderate deterioration judgment threshold values first with respect to the number of years in use and then with respect to the traveled distance. Alternatively, a judgment may be made as to whether or not there are more moderate deterioration judgment threshold values with respect to the number of years in use or the traveled distance only.

In step S25, as will be described later, a judgment may be made as to whether or not there are stricter deterioration judgment threshold values, rather than whether or not there are more moderate deterioration judgment threshold values.

If more moderate deterioration judgment threshold values exist (step S25: YES), then in step S26, the PC 42 (deterioration diagnosing function 118) selects the more moderate deterioration judgment threshold values.

If more moderate deterioration judgment threshold values do not exist (step S25: NO), then in step S27, the PC 42 (deterioration diagnosing function 118) selects designed maximum tolerances as the deterioration judgment threshold values. For example, if the number of years in use is 0.5 (and up to 1) and the traveled distance is 12000 km (and up to 15000 km) in FIG. 10, then no measured threshold value flags exist, even if there is an increase in one of the number of years in use and the traveled distance. In this case, the PC 42 (deterioration diagnosing function 118) selects the designed maximum tolerances as the deterioration judgment threshold values.

As described later, the effect of either the ambient temperature or the atmospheric pressure may be reflected in the deterioration judgment threshold values.

### (3-2-3. Advance Setting of Deterioration Judgment Threshold Value)

A process of setting the deterioration judgment threshold value in advance will be described below.

(1) Designed Maximum Tolerance

A designed maximum tolerance is set by a vehicle designer who designs the same vehicle types that serve as the diagnostic target vehicle 12. After a designed maximum tolerance has initially been set, the designed maximum tolerance may be changed. The designed maximum tolerance is input to the vehicle DB 150 of the server 16 by a developer of the diagnostic software used by the PC 42 (hereinafter referred to as a “software developer”), and are updated as needed in the vehicle DB 130 of the PC 42.

(2) Deterioration Judgment Threshold Value Based on Actual Value Data at a Time of Inspection Upon Shipment from Factory

Actual value data are acquired by an inspector or a manufacturing apparatus at the manufacturing factory that manufactures the same vehicle types that serve as the diagnostic target vehicle 12. The software developer sets the deterioration judgment threshold values based on the acquired actual value data. For example, the software developer may set the values of sigma, 2 sigma, and 3 sigma, which serve as deterioration judgment threshold values with respect to a standard error. Rather than the software developer setting the deterioration judgment threshold values, the server 16 or the like may have a threshold value calculating device, and the manufacturing apparatus may send data to the threshold value calculating device, whereupon the calculating device may automatically calculate and set the deterioration judgment threshold values. The deterioration judgment threshold values may be updated as needed based on actual value data when the number of shipped vehicles increases. The updated deterioration judgment threshold values are stored in the vehicle DB 150 of the server 16, and are updated as needed in the vehicle DB 130 of the PC 42.

(3) Deterioration Judgment Threshold Value Based on Aging Data after Shipment

Aging data after shipment are acquired by the technician at a dealer, a repair shop, or the like, while operating the tester 40, and the aging data are stored in the memory 72. The aging data acquired through the tester 40 are output to the PC 42, which then sends the aging data to the management server 16. When the PC 42 sends the aging data to the management server 16, the PC 42 also sends a classification (vehicle type, model, or the like) for identifying the diagnostic target vehicle 12, the number of years in use, and the traveled distance.

The management server 16 stores the aging data in the vehicle DB 150 according to the combinations of classifications (vehicle types, models, or the like), the numbers of years in use, and the traveled distances. The processor 144 of the management server 16 sets the deterioration judgment threshold values based on the aging data stored in the vehicle DB 150. For example, the processor 144 may set the values of sigma, 2 sigma, and 3 sigma as deterioration judgment threshold values.

Since the aging data are sent as needed to the management server 16, the deterioration judgment threshold values are updated as needed when the aging data increase in number. The deterioration judgment threshold values, which are set in the foregoing manner, are stored in the vehicle DB 150 of the server 16, and are updated as needed in the vehicle DB 130 of the PC 42.

### (3-3. Comparison Between Acquired Target Data and Deterioration Judgment Threshold Values)

FIG. 12 is a flowchart of a sequence for comparing the acquired target data and the deterioration judgment threshold values (details of step S14 of FIG. 5). In step S41, the PC 42 (deterioration diagnosing function 118) calculates an average value, a maximum value, and a minimum value of target data with respect to each of the diagnostic target items. As described above, the diagnostic target items may include, for example, an engine rotational speed Ne, a throttle sensor voltage, a coolant temperature sensor voltage, an intake temperature sensor voltage, an intake pressure sensor voltage, an atmospheric pressure sensor voltage, a fuel injection quantity, an ignition timing, an idling air control valve opening, a battery voltage, and an oil temperature sensor voltage.

In step S42, the PC 42 (deterioration diagnosing function 118) compares the average value, the maximum value, and the minimum value with respect to a diagnostic target item, which has been selected as a comparison target from among all of the diagnostic target items, with the deterioration judgment threshold value that was set in step S13 of FIG. 5.

In step S43, the PC 42 (deterioration diagnosing function 118) judges whether or not any of the average value, the maximum value, and the minimum value falls within the deterioration judgment threshold value. If any of the average value, the maximum value, and the minimum value falls within the deterioration judgment threshold value (step S43: YES), then in step S44, the PC 42 (deterioration diagnosing function 118) judges that the diagnostic target item is not suffering from deterioration. The expression “not suffering from deterioration” implies that the diagnostic target item does not need to be repaired or replaced.

If any one of the average value, the maximum value, and the minimum value does not fall within the deterioration judgment threshold value (step S43: NO), then in step S45, the PC 42 (deterioration diagnosing function 118) judges whether or not the average value falls within the deterioration judgment threshold value. If the average value falls within the deterioration judgment threshold value (step S45: YES), then in step S46, the PC 42 (deterioration diagnosing function 118) judges that the diagnostic target item is somewhat deteriorated but has no problem. The expression “the diagnostic target item is somewhat deteriorated but has no problem” implies that the diagnostic target item needs to be diagnosed again, or repaired or replaced within a predetermined period or a predetermined traveled distance, for example.

If the average value does not fall within the deterioration judgment threshold value (step S45: NO), then in step S47, the PC 42 (deterioration diagnosing function 118) judges that the diagnostic target item needs to be inspected because the diagnostic target item is deteriorated.

The judgment results from step S44, step S46, and step S47 are used to impart different colors to the framed displays 252a through 252h on the visual display screen 250 (FIG. 7), as well as to impart different colors to the degree-of-deterioration display fields 266a through 266f on the list display screen 260 (FIG. 8).

After step S44, S46, or S47, in step S48, the PC (deterioration diagnosing function 118) saves the measured data, which are used for comparison with respect to the diagnostic target item as the comparison target, in the vehicle DB 130. More specifically, the PC 42 (deterioration diagnosing function 118) saves in the vehicle DB 130 the average value, the maximum value, and the minimum value with respect to the diagnostic target item as the comparison target, together with the classification (vehicle type, model, or the like), the number of years in use, and the traveled distance of the diagnostic target vehicle 12. As described above, the saved data are sent to the server 16 at the time that the measured threshold value identifying map 300 and the deterioration judgment threshold value identifying map 302 are updated. Thereafter, the server 16 stores the received and saved data in the vehicle DB 150 for use in setting the deterioration judgment threshold values.

In the next step S49, the PC 42 (deterioration diagnosing function 118) confirms whether or not the comparison process has been completed with respect to all of the diagnostic target items. If there is a diagnostic target item for which the comparison process has not yet been completed (step S49: NO), then in step S50, the PC 42 (deterioration diagnosing function 118) switches to the diagnostic target item as a comparison target, after which control returns to step S42. If the comparison process has been completed with respect to all of the diagnostic target items (step S49: YES), then the sequence in the present cycle is brought to an end.

### [4. Advantages of the Present Embodiment]

According to the present embodiment, as described above, a plurality of deterioration judgment threshold values for judging degrees of deterioration of the diagnostic target vehicle 12 with respect to diagnostic target items are set depending on the number of years in use and the traveled distance of the diagnostic target vehicle 12, in relation to each of the diagnostic target items and with respect to the degrees of deterioration (FIGS. 10 and 11). Consequently, it is possible to diagnose the diagnostic target items as having one of a plurality of degrees of deterioration, e.g., not deteriorated (step S44 of FIG. 12), somewhat deteriorated but no problem (step S46), and deteriorated and to be inspected (step S47), etc. Therefore it is possible to perform a balanced diagnosis on the vehicle 12 in order to prevent the vehicle 12 from suffering from faults, and to diagnose the vehicle 12 depending on the degree of deterioration thereof.

According to the present embodiment, the deterioration judgment threshold values include deterioration judgment threshold values based on actual value data obtained when a plurality of vehicles, which are included in the same classification as the diagnostic target vehicle 12, are inspected upon shipment from the factory, and also include deterioration judgment threshold values depending on the numbers of years in use and the traveled distances of the vehicles after the vehicles are sold. The deterioration judgment threshold values are set in a range so as not to exceed the designed maximum tolerances for the vehicles (see FIGS. 10 and 11).

Generally, as the number of years in use or the traveled distance of a vehicle becomes greater, components of the vehicle tend to develop greater specification variations. When the vehicle is shipped from the factory, therefore, specification variations may be smaller than the designed maximum tolerances. With the above arrangement of the present embodiment, the deterioration judgment threshold values are set depending on the degree of aging, within a range so as not to exceed the designed maximum tolerances (see FIGS. 10 and 11). Accordingly, the degree of deterioration of a diagnostic target item can be judged depending on the number of years in use or the traveled distance. Therefore, even if target data (detected values from the various sensors 24) fall within the designed maximum tolerances, the progress of deterioration can be judged as being relatively fast, etc., thereby leading to a more appropriate diagnosis.

According to the present embodiment, if deterioration judgment threshold values, which are in agreement with the degree of aging of the diagnostic target vehicle 12, do not exist or cannot be used (step S23: NO in FIG. 9), and if there are more moderate deterioration judgment threshold values based on measured data (step S25: YES), then the more moderate deterioration judgment threshold values are selected (step S26). Consequently, if deterioration judgment threshold values, which are in agreement with the number of years in use and the traveled distance of the diagnostic target vehicle 12, do not exist (due to a shortage of samples or a reduction in the reliability of the deterioration judgment threshold values for some reason), it is still possible to perform a diagnosis using relatively appropriate deterioration judgment threshold values, rather than using the designed maximum tolerances.

Furthermore, target data are saved as threshold value data, which correspond to the number of years in use and the traveled distance of the diagnostic target vehicle 12. By using the target data during setting of the subsequent deterioration judgment threshold values, it is possible for a greater number of samples to be reflected in the deterioration judgment threshold values.

According to the present embodiment, the PC 42 acquires target data of a diagnostic target item a plurality of times (step S12 of FIG. 5), calculates an average value, a maximum value, and a minimum value thereof (step S41 of FIG. 12), and compares the average value, the maximum value, and the minimum value with a plurality of deterioration judgment threshold values (step S42). Therefore, the degree of deterioration of the diagnostic target vehicle 12 can be diagnosed in detail.

According to the present embodiment, the vehicle diagnosing system 10 includes the server 16 for sending a plurality of deterioration judgment threshold values to a plurality of external diagnosing apparatus 14. The plural external diagnosing apparatus 14 send data to the server 16, which represent pairs of target data acquired from diagnostic target vehicles 12 and the numbers of years in use and the traveled distances thereof. The server 16 corrects the deterioration judgment threshold values using the data, which represent the pairs of the target data received from the plural external diagnosing apparatus 14 and the numbers of years in use and the traveled distances thereof, and thereafter, sends the corrected deterioration judgment threshold values to the plural external diagnosing apparatus 14. Consequently, the number of samples for setting a plurality of deterioration judgment threshold values can be increased, thus making it possible to set a plurality of deterioration judgment threshold values more appropriately.

### B. Modifications

The present invention is not limited to the above embodiment. The present invention may employ various alternative arrangements based on the disclosure of the present description. For example, the present invention may employ the following arrangements.

### [1. Diagnostic Target (Vehicle 12)]

The vehicle 12 according to the above embodiment is a gasoline vehicle. However, vehicles that can be diagnosed by the external diagnosing apparatus 14 may include a diesel engine vehicle, an electric automobile, a hybrid vehicle, or the like. Similarly, although the vehicle 12 according to the present embodiment is illustrated as a motorcycle, vehicles that can be diagnosed by an external vehicle diagnosing apparatus may include a three-wheeled vehicle, a four-wheeled vehicle, a six-wheeled vehicle, or the like.

According to the above embodiment, the external diagnosing apparatus 14 (the tester 40 and the PC 42) is used in connection with the vehicle 12. However, as long as attention is paid to the functions of the external diagnosing apparatus 14, the external diagnosing apparatus can be used in connection with other apparatus aside from the vehicle 12, e.g., a mobile object such as a ship, an aircraft, or the like, or a manufacturing apparatus such as a machine tool or the like.

### [2. Configuration of External Diagnosing Apparatus 14]

According to the above embodiment, the external diagnosing apparatus 14 is composed of the tester 40 and the PC 42. However, the external diagnosing apparatus 14 is not limited to such a combination. If the tester 40 comprises a high-functionality portable terminal device, such as a tablet computer, a smart phone, or the like, the PC 42 and the tester 40 may be combined integrally with each other.

According to the above embodiment, the PC 42 communicates with the ECU 20 via the tester 40. However, the PC 42 is not limited to such a communications scheme. The PC 42 and the ECU 20 may communicate directly with each other through a wireless or a wired link. A laptop personal computer, for example, which serves as the PC 42, may incorporate the functions of the tester 40.

According to the above embodiment, diagnostic software used by the tester 40 is stored in advance in the memory 72 of the tester 40. However, the diagnostic software need not necessarily be stored in the memory 72. Alternatively, rather than being downloaded, the diagnostic software may be downloaded from the PC 42 or an external source, e.g., an external server that can communicate via a public network, or may be executed as a program provided by an application service provider (ASP). In addition, the diagnostic software used by the PC 42 is stored in advance in the memory 98 of the PC 42. However, the diagnostic software need not necessarily be stored in the memory 98, but may be downloaded from an external source, e.g., the external server referred to above, or may be executed as a program provided by an ASP.

### [3. Deterioration Diagnosis]

According to the above embodiment, deterioration judgment threshold values are stored in the memory 98 of the PC 42. However, the deterioration judgment threshold values need not necessarily be stored in the memory 98. Information required to identify the deterioration judgment threshold values for performing a deterioration diagnosis (hereinafter referred to as “threshold identifying information”) may be sent from the PC 42 to the server 16. In this case, the server 16 may identify the deterioration judgment threshold values based on the threshold specifying information, and send the identified deterioration judgment threshold values to the PC 42.

According to the above embodiment, combinations of the numbers of years in use and the traveled distances are used to identify deterioration judgment threshold values. However, the combinations of the numbers of years in use and the traveled distances may not necessarily be used to identify degrees of deterioration or degrees of aging. Either the numbers of years in use or the traveled distances may be used to identify degrees of deterioration or degrees of aging. Alternatively, at least one of the ambient temperature and the atmospheric pressure may be used to identify deterioration judgment threshold values.

More specifically, certain diagnostic target items are affected by the ambient temperature or the atmospheric pressure. For acquiring sample data for setting deterioration judgment threshold values, the numbers of years in use and the traveled distances may be acquired separately according to respective regions having different ambient temperatures and atmospheric pressures, and deterioration judgment threshold values may be set based on the numbers of years in use and the traveled distances thus acquired. In this case, when performing the deterioration diagnosis, by acquiring an ambient temperature and an atmospheric pressure in addition to the number of years in use and the traveled distance, it is possible to set more appropriate deterioration judgment threshold values so that the deterioration diagnosis can be performed more accurately.

As described above, if a diagnostic target component is replaced or repaired, not only the number of years in use and the traveled distance of the diagnostic target vehicle 12 per se, but also the number of years in use and the traveled distance of the diagnostic target vehicle 12 after usage of the repaired or replaced diagnostic target component has started may be used.

According to the above embodiment, deterioration judgment threshold values are set on the basis of designed maximum tolerances, measured data (actual value data) of the performance of components at the time of inspection upon shipment from the factory, and measured data (aging data) of the performance of components depending on the number of years in use and the traveled distance (see FIGS. 10 and 11). However, the deterioration judgment threshold values need not necessarily be set in this way, insofar as the deterioration judgment threshold values are identified based on the degree of deterioration or the degree of aging. Further, deterioration judgment threshold values may be set based only on designed maximum tolerances and aging data.

According to the above embodiment, particular classifications (vehicle types, models, etc.) are used in addition to the numbers of years in use and the traveled distances in order to identify or save deterioration judgment threshold values. However, the classifications are not limited to vehicle types or models, but may be various other classifications, insofar as such classifications can classify the deterioration judgment threshold values. Further, if there is only one vehicle type to be diagnosed using the deterioration judgment threshold values, or stated otherwise, if the vehicle diagnosing system 10 is used in connection only with a particular vehicle type, then the external diagnosing apparatus 14 or the server 16 may dispense with the process of identifying a classification such as a vehicle type or the like.

According to the above embodiment, target data are acquired a plurality of times from a diagnostic target item (or a particular sensor) (step S12 of FIG. 5), and an average value, a maximum value, and a minimum value of the acquired target data are compared with deterioration judgment threshold values (step S42 of FIG. 12). However, such a process is not restrictive, insofar as the degree of deterioration of the diagnostic target item can be diagnosed. Only one or two of the average value, the maximum value, and the minimum value, for example, may be used. Alternatively, the target data may be acquired only one time.

According to the above embodiment, each of an average value, a maximum value, and a minimum value is compared with a deterioration judgment threshold value (FIG. 11 and step S42 of FIG. 12). However, such a process is not restrictive, insofar as deterioration of the diagnostic target item can be diagnosed. Different deterioration judgment threshold values may be set with respect to an average value, a maximum value, and a minimum value, respectively.

According to the above embodiment, the deterioration judgment threshold values are updated by the server 16. However, such an updating process is not restrictive, insofar as the deterioration judgment threshold values can be updated. For example, a recording medium such as a CD-ROM, a DVD, a flash memory, or the like may be sent to dealers to update the deterioration judgment threshold values of each PC 42.

According to the above embodiment, if deterioration judgment threshold values do not exist that are in agreement with the number of years in use and the traveled distance (step S23: NO in FIG. 9), and if there are more moderate deterioration judgment threshold values based on the measured data (step S25: YES), then the more moderate deterioration judgment threshold values are selected (step S26). However, such a process is not restrictive, insofar as deterioration judgment threshold values can be selected depending on the degree of deterioration or the degree of aging. If deterioration judgment threshold values do not exist that are in agreement with the number of years in use and the traveled distance (step S23: NO in FIG. 9), then the designed maximum tolerances may be selected.

Alternatively, the “more moderate deterioration judgment threshold values” in step S25 and step S26 may be replaced with “stricter deterioration judgment threshold values”. The expression “stricter deterioration judgment threshold values” represents a smaller number of years in use or a shorter traveled distance.

For example, if the number of years in use is 2.5 (and up to 3) and the traveled distance is 500 km (and up to 1000 km) in the measured threshold value identifying map 300 of FIG. 10, then a state of “NO DATA” exists in the map 300. However, if the number of years in use is up to 2 and the traveled distance is up to 1000 km, then a measured threshold value flag “X2-Y1” exists. As described above, as the number of years in use becomes smaller, the deterioration judgment threshold values exist within a narrower (stricter) range.

If the number of years in use is 0.5 (and up to 1 year) and the traveled distance is 6000 km (and up to 10000 km), then a state of NO DATA″ exists in the measured threshold value identifying map 300. However, if the traveled distance is up to 5000 km and the number of years in use is up to 1, then a measured threshold value flag “X1-Y2” exists. As described above, as the traveled distance becomes shorter, the deterioration judgment threshold values exist within a narrower (stricter) range.

For identifying stricter deterioration judgment threshold values, for example, the existence of stricter deterioration judgment threshold values (of a shorter traveled distance) is judged with respect to the traveled distance, and if a corresponding measured threshold value flag does not exist therefor, the existence of stricter deterioration judgment threshold values (of a shorter period in use) is judged with respect to the number of years in use. Alternatively, the existence of stricter deterioration judgment threshold values (of a shorter period in use) may be judged with respect to the number of years in use, and if a corresponding measured threshold value flag does not exist therefor, the existence of stricter deterioration judgment threshold values (of shorter traveled distance) may be judged with respect to the traveled distance. Further, alternatively, the existence of stricter deterioration judgment threshold values (of a shorter period in use) may be judged with respect only to the number of years in use, or the existence of stricter deterioration judgment threshold values (of a shorter traveled distance) may be judged with respect only to the traveled distance.

If deterioration judgment threshold values, which are in agreement with the number of years in use and the traveled distance (degree of aging) of the diagnostic target vehicle 12, do not exist or cannot be used (due to a shortage of samples or a reduction in the reliability of the deterioration judgment threshold values for some reason), then a diagnosis is performed using stricter deterioration judgment threshold values. Consequently, it is possible to avoid ignoring an excessive increase in the degree of deterioration. If measured data that are saved in this case are collected and accumulated, the measured data can be used as threshold value data for setting threshold values corresponding to degrees of aging that do not actually exist.

1. An external diagnosing apparatus for performing data communication with an electronic control unit installed on a diagnostic target vehicle from outside the diagnostic target vehicle to acquire detected values from sensors on the diagnostic target vehicle through the electronic control unit, and diagnosing the diagnostic target vehicle, wherein
the external diagnosing apparatus compares a plurality of threshold values set with respect to degree of deterioration of the diagnostic target vehicle and set also depending on degree of aging of the diagnostic target vehicle with respect to a diagnostic target item, with an average value, a maximum value, and a minimum value calculated by acquiring the detected values with respect to the diagnostic target item a plurality of times, for thereby judging the degree of deterioration of the diagnostic target vehicle with respect to the diagnostic target item based on a combination of results of the comparison.

2. The external diagnosing apparatus according to claim 1, wherein the plurality of threshold values include:
threshold values based on measured values or actual values at time of an inspection upon shipment from a factory with respect to a plurality of vehicles included in same classification as the diagnostic target vehicle or having equivalent performance to the diagnostic target vehicle; and
threshold values based on measured values or actual values depending on numbers of years in use or traveled distances of the vehicles after the vehicles are sold; and
wherein the plurality of threshold values are set in a range not exceeding designed maximum tolerances related to the vehicles.

3. The external diagnosing apparatus according to claim 1, wherein if threshold values that agree with the degree of aging of the diagnostic target vehicle do not exist among the plurality of threshold values or cannot be used, threshold values set for vehicles whose degree of aging is smaller than the diagnostic target vehicle are selected, and the detected values are saved as threshold value data for setting threshold values corresponding to the degree of aging of the diagnostic target vehicle.

4. A vehicle diagnosing system having a plurality of external diagnosing apparatus for performing data communication with an electronic control unit installed on a diagnostic target vehicle from outside the diagnostic target vehicle to acquire detected values from sensors on the diagnostic target vehicle through the electronic control unit, and diagnosing the diagnostic target vehicle,
wherein each external diagnosing apparatus compares a plurality of threshold values set with respect to degree of deterioration of the diagnostic target vehicle and set also depending on degree of aging of the diagnostic target vehicle with respect to a diagnostic target item, with an average value, a maximum value, and a minimum value calculated by acquiring the detected values with respect to the diagnostic target item a plurality of times, for thereby judging the degree of deterioration of the diagnostic target vehicle with respect to the diagnostic target item based on a combination of results of the comparison,
wherein the vehicle diagnosing system comprises:
a server configured to set the plurality of threshold values and sending the plurality of threshold values to the plurality of external diagnosing apparatus;
wherein the plurality of external diagnosing apparatus send data that represent pairs of the detected values acquired from the diagnostic target vehicle and the degree of aging thereof to the server; and
the server corrects the plurality of threshold values using the data that represent pairs of the detected values and the degree of aging and which are received from the plurality of external diagnosing apparatus, and send the corrected plurality of threshold values to the plurality of external diagnosing apparatus.

5. A vehicle diagnosing method of performing data communication with an electronic control unit installed on a diagnostic target vehicle and an external diagnosing apparatus to acquire detected values from sensors on the diagnostic target vehicle into the external diagnosing apparatus for diagnosing the diagnostic target vehicle, the vehicle diagnosing method comprising:
setting a plurality of threshold values depending on degree of aging of the diagnostic target vehicle and degree of deterioration of thereof with respect to a diagnostic target item;
acquiring the detected values with respect to the diagnostic target time a plurality of times;
calculating an average value, a maximum value, and a minimum value of the acquired detected values; and
comparing the set plurality of threshold values with each of the average value, the maximum value, and the minimum value to judge the degree of deterioration of the diagnostic target vehicle with respect to the diagnostic target item based on a combination of results of the comparison.

6. (canceled)
